(19) United States
(12) Patent Application Publication
(10) Pub. No.: US 2007/0063512 A1
(43) Pub. Date: Mar. 22, 2007

(54) Firehose coupling exit indicator

(76) Inventor: Isidro Tamez JR., Houston, TX (US)

Correspondence Address: ANDREWS & KURTH, L.L.P., 600 TRAVIS, SUITE 4200, HOUSTON, TX, 77002, US

(21) Appl. No.: 11/230,707

(22) Filed: Sep. 20, 2005

(51) Int. Cl. F16L 19/00

(52) U.S. Cl. 285/354; 285/93

(57) ABSTRACT

An indicator device captured between couplers of ends of firehose sections that point to the source of the firehose and to safety. The preferred embodiment includes gasket-like annular body which fits over the male threads of the male coupler and is captured between annular ends of the abutting male and female coupler bodies. Direction pointing fingers, integral with the annular body, point backward toward the hose section to which the male coupler is attached and are angularly oriented to fit between longitudinal lugs of the male coupler.

### BACKGROUND OF THE INVENTION

1. Field of the Invention

This invention concerns indicators associated with a firehose to help a firefighter find his way to safety via the firehose from a smoke-filled building.

2. Description of Prior Art

A primary concern of fire fighting personnel is that of becoming lost in a burning or smoke-filled structure where the firefighter does not know the direction to the outside. Firefighters are commonly taught to follow the firehose lines, knowing that the firehose connects from an outside source of water to the water spraying nozzle. However, under the stresses and pressures of a fire emergency, a firefighter may lose his sense of direction, and upon finding a firehose may be unable to conclude which direction leads to the outside water source and which direction leads to the nozzle. As explained in U.S. Pat. No. 4,884,000, innumerable other problems can arise which further minimize the chances of a safe escape.

U.S. Pat. No. 4,884,000, issued Jul. 4, 1989 to Clement, describes a flexible band or clamp with directional fingers protruding perpendicularly from the band. The band is attached to the firehose and helps indicate the direction to the water connection source of the firehose. The clamp of the '000 patent allows a firefighter to feel along the firehose and determine the direction to the exit. The clamp is a flexible removable band which must be retrofitted along the length of the firehose. The embodiments described include a steel spring clamp capable of being slipped over an unrolled firehose and a flexible band with fastener which encircles the firehose and may remain on a stored firehose. U.S. Pat. No. Des. 312,390 issued Nov. 7, 1990 and U.S. Pat. No. 345,519 issued Mar. 29, 1994, both to Clement, show various embodiments of the directional bands as essentially described in Clement's '000 patent.

Problems are inherent in a device which must be attached by encircling a firehose: Such a device must be able to withstand heat; must be able to withstand sudden expansion or change in shape caused by the high water pressure through a firehose; must be able to withstand abuse to its surface when being dragged over rough surfaces; and must be able to avoid snagging objects and hampering movement of the firehose. Yet, simultaneously, the device must also be able to remain sufficiently flexible to allow the firehouse to be stored in a flattened coil or roll; must be able to avoid restriction of water flow by kinking a firehose; and more importantly, must be able to withstand being dislodged or removed through abuse of the hose so that the device is there when the firefighter needs it.

U.S. Pat. No. 5,027,741, issued Jul. 2, 1991 to Smith et al, addresses many of these problems in two embodiments of an emergency escape firehose. The '741 embodiments incorporate stiff bristles permanently interwoven at an angle into the canvas surface of a firehose. In the first embodiment, the fibers' angle points towards the connection of the firehose with the water source so enabling a firefighter to feel a smooth surface in that direction and a resistant surface in the direction towards the nozzle connection. In the second embodiment, the fiber angles are reversely inclined and the firefighter must know that the direction towards the resistant feel of the firehose will lead him to the water source connection.

However, when a firefighter is faced with an extreme emergency or panic circumstance, a safety escape device should also be intuitive to use so as to minimize the need for use of cognitive skills. A rookie firefighter trying to remember whether the rough direction is to the fire or to the source has no intuitive clues whether “smooth” is out or “rough” is out. In contrast, everyone intuitively understands a pointer or directional arrow.

The third and fourth embodiments of the '741 patent include a series of annular members attached to the outer surface of the firehose wherein the annular member is inclined to indicate direction. A fifth and sixth embodiment include application of a luminous tapered stripe to the firehose. While these embodiments are more intuitive, they too have the same problems and disadvantages as previously noted.

U.S. Pat. No. 5,623,890 describes a firehose coupling comprising male and female components which thread together to connect firehose sections. The male coupling component always indicates the direction of water flow. The '890 patent discloses an elongated extension integrally attached to each lug of a male component of a firehose coupling. Such lugs are costly to manufacture and require large capital expenditures to provide new coupling sets to equip many firehoses for a large city fire department.

U.S. Pat. No. 6,766,761, incorporated herein by reference, addresses many shortcomings with a firehose coupling exit indicator which is secured between the male and female hose coupler ends. The indicator includes a plastic ring which fits between and is captured by the mated male and female coupler hose ends which has integral triangular fingers that extend from the ring along the outer surface of the male hose coupler end. The triangular fingers act as arrows which point the way to the firehose source and building exit to aid the firefighter in egress. However, additional safety features which further increase the effectiveness and sturdiness of the fire hose coupling indicator of the '761 patent are desirable.

3. Identification of Objects of the Invention

A primary object of the invention is to provide a direction indicating device at the coupling between firehose sections that is inexpensive to manufacture, yet provides a reliable indicator toward the hose source for a firefighter in a dark, smoke-filled building.

Another object of the invention is to provide an inexpensive direction indicating device that can be attached to couplings of existing firehoses so that entire new couplings need not be purchased.

Another object of the invention is to provide a direction indicating device at the coupling between firehose sections that provides a reliable tactile indicator of the firehose source direction for a firefighter wearing the thick gloves of a firefighting ensemble in a dark, smoke-filled building.

Another object of the invention is to provide a direction indicating device at the coupling between firehose sections that provides a reliable visual indicator toward the hose source for a firefighter in a dark, smoke-filled building.

### SUMMARY OF THE INVENTION

The objects identified above along with other advantages and features are preferably embodied in an annular indicating device which fits over the male threads of a male coupling of a firehose. The indicating device has integral indicating fingers which point backward from the coupling toward the hose source. Such fingers fit in the gaps of the lugs of the male coupling. In one embodiment, the fingers are shaped like arrowheads and have deep arrow-shaped relief grooves or raised ridges on the outer faces so that a firefighter can easily determine by feel the direction to which they are pointing. Furthermore, the fingers of the device increase in thickness toward the pointed end and may extend axially longitudinally well beyond the male hose coupler end to provide a further tactile indicator of the direction toward the firehose source. The indicating device is preferably made of a strong engineering thermoplastic and/or rubber material which includes luminescent, phosphorescent, fluorescent and/or reflective particles therein for enhanced visual indication of the direction towards safety. The raised or recessed arrowhead-shaped indicia may have a coating which is in sharp contrast to the outward-facing surfaces of the fingers for additional visual recognition.

### BRIEF DESCRIPTION OF THE DRAWINGS

The objects, advantages and features of the invention will become more apparent by reference to the drawings which are appended hereto and wherein an illustrative embodiment of the invention is shown, of which:

FIG. 1 is a front perspective view of the indicator device according to one embodiment of the invention showing an annular ring with integral arrowhead-shaped fingers and arrowhead-shaped relief groove indicia thereon for covering a male firehose coupler;

FIG. 2 is a rear perspective view of the indicator device of FIG. 1 showing a recess for accommodating the shoulder of a female firehose coupler and the arrowhead-shaped fingers with arrow-shaped relief groove indicia thereon;

FIG. 3 is a perspective explosion diagram of an indication device FIGS. 1 and 2 placed between male and female firehose coupler ends showing the indication device fingers which circumscribe the male coupler end of a firefighting hose section to indicate the direction of the firehose source;

FIG. 4 is a perspective view of an assembled firehose coupling assembly of FIG. 3 with the firehose sections not shown for clarity;

FIG. 5 is a longitudinal cross section of the assembled firehose coupling assembly of FIG. 4 showing the indication device of FIGS. 1 and 2 captured between the male and female coupler sections; and

FIG. 6 is a perspective view of an assembled firehose coupling assembly having an alternate embodiment of an identification device according to the invention assembled therewith showing a rough textured outward facing surface and raised arrowhead-shaped indicia thereon.

### DETAILED DESCRIPTION OF THE PREFERRED EMBODIMENTS

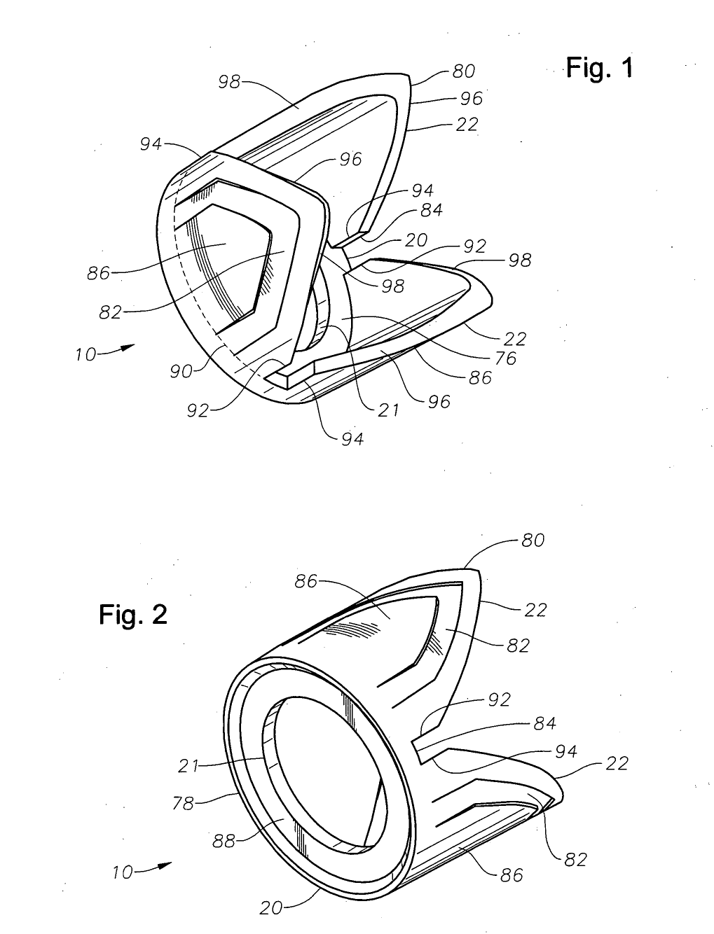

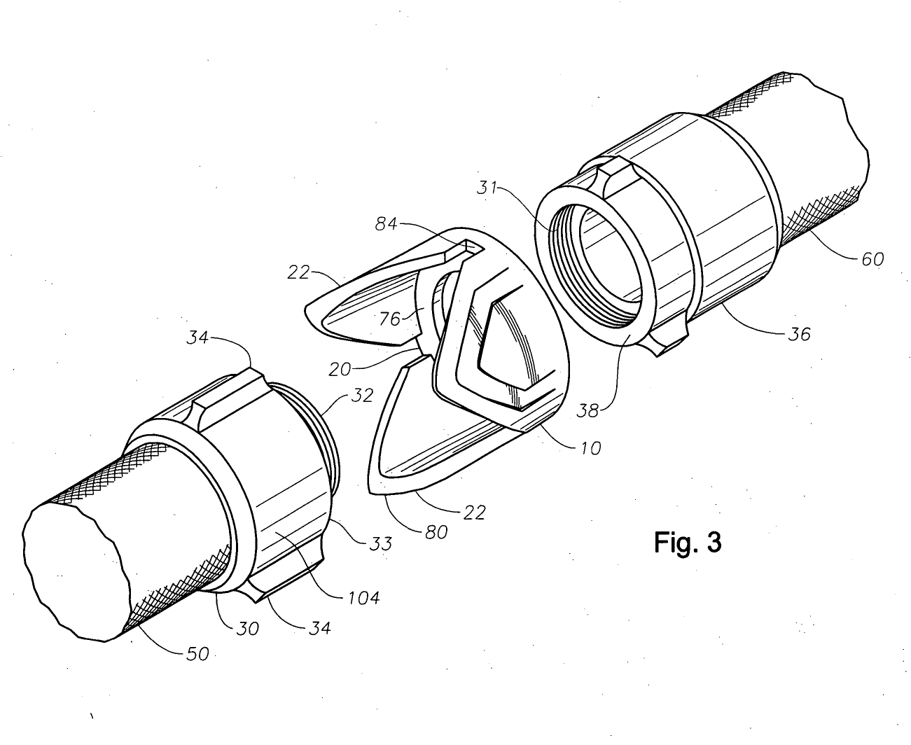

FIGS. 1 and 2 illustrate the firehose indicating device 10 according to a preferred embodiment of the invention. The indicating device 10 includes a generally planar annular body 20 with aperture 21. Referring to FIG. 1, the annular body has a first face 76 from which a plurality of arrowhead-shaped circumferential fingers 22 extend perpendicularly in a common direction from the plane of body 20. FIGS. 1 and 2 show three fingers 22, but a different number of fingers may be suitable. Preferably, fingers 22 are integral with body 20 and are circumferentially spaced about body 20 so as to define an equal number of narrow slots 84.

Ideally, each finger 22 has an irregular pentagon shape defined by a first, base edge 90 (formed by a circumferential portion of body 20), second and third side edges 92, 94 which extend perpendicularly to the plane of body 20, and fourth and fifth edges 96, 98 which close the pentagon and generally form an arrowhead shape. The tips 80 of fingers 22 (defined by the apex portion of the fourth and fifth edges 96, 98), and other vertices, may be slightly rounded if desired. Furthermore, the fingers 22 may be thicker at the tip 80 than they are near body 20.

Referring to FIG. 2, annular body 20 has an obverse face 78 opposite to the first face 76 (FIG. 1). The obverse face preferably includes a circular recess 88 centered in annular body 20 which accommodates the annular shoulder 38 of female coupler 36 and allows for hand or spanner wrench tightening to prevent water leaks at the coupler connection.

Referring to FIGS. 1 and 2, each finger 22 preferably includes an indicium 82 on its outward-facing surface 86. The indicia 82 are ideally shaped to resemble an arrowhead pointing in the same direction as the arrowhead-shaped fingers 22. Each indicium 82 is preferably a recess formed by a wide and deep groove so that it's direction can be readily identified even by a firefighter wearing the thick gloves of a firefighting ensemble. Alternatively, the indicia 82 may be raised above the outward-facing surfaces 86 of fingers 22 in such a manner as to promote identification of the arrowhead direction by a firefighter.

FIGS. 3-5 illustrate how the indicating device 10 is used in conjunction with a firehose coupling assembly. As shown in FIG. 3, the body 20 is like a gasket in that it extends over the end of male coupler 30 at the end of a hose section 50 with aperture 21 receiving the male threads 32. The first face 76 of body 20 abuts the annular shoulder 33 of male coupler 30. The direction-indicating fingers 22 are spaced about body 20 so as to fit between and abut lugs 34 of male coupler 30, covering a portion of the interposal coupler surfaces 104 (FIG. 3) (defined between two adjacent lugs 34). In other words, the lugs 34 of male coupler 30 are received into fitted slots 84. Three lugs 34 are common for firehouse couplers, so three direction indicating fingers are provided for such couplers, but four fingers are provided for couplers with four lugs, etc. Preferably, arrowhead fingers 22 have increasing thickness toward their tips 80, but the thickness is arranged so that the arrowhead fingers 22 do not extend radially beyond the radial extent of the coupling lugs, so that the fingers will be protected from damage during use.

As shown in FIG. 3, coupled hose sections 50, 60 are selectively connected to each other by male and female threaded couplers 30, 36. The annular body 20 of indicating device 10 is captured between annular shoulders 33, 38 of couplers 30, 36 when the female threads 31 of coupler 36 are threaded onto the male threads 32 of coupler 30. The integral fingers 22 fit between lugs 34 of the male coupler 30 and point toward the firehose water source (i.e., the fire plug) and away from the end of the hose where a nozzle is typically provided and carried to the fire inside a building.

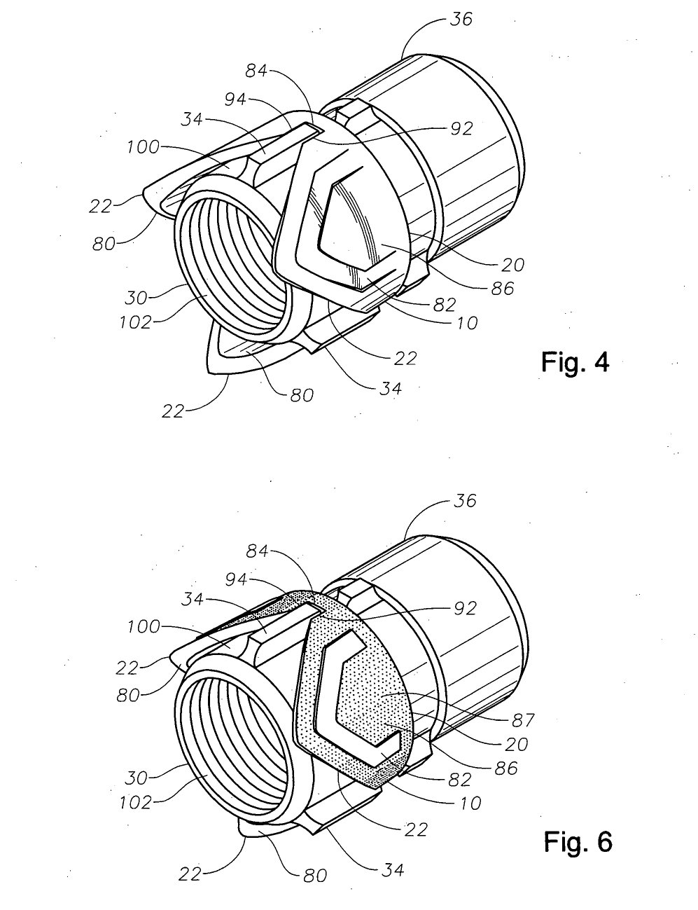

FIG. 4 illustrates the firehouse coupling assembly with indicator device 10 when the female coupler 36 is threaded about the male coupler 30. For clarity, the firehose sections 50 and 60 are not illustrated, and the internal serrated barbed surface 102 of male coupler 30 which captures the fabric firehose is visible. As illustrated in FIG. 4, it is desirable for fingers 22 to cover the entire circumferential portion of male couple body 30 near body 20, or as much as possible, to provide structural strength. By abutting fingers sides 92, 94 with the lugs 34, or in other words, by providing fitted slots 84 to receive the lugs, the finger-body interface is made stronger by a having a longer length and a greater amount of curvature; thus, fingers 22 are less likely to break apart from body 20 if they snag on an object as the firehose is being dragged about. Fingers 22 are also preferably quite thick for strength and rigidity. Therefore, the depth of the slots 84 is ideally short enough to allow clearance for spanner wrenches to easily engage lugs 34. In other words, side edges 92, 94 are designed to be long enough to provide finger strength, but short enough to provide spanner wrench clearance space 100 around each lug 34.

With the indicating device supplied at each hose section coupling, a firefighter in a dark smoke-filled burning building can find a firehose and feel for the couplings, and upon feeling or seeing the arrowhead-like fingers 22 between lugs 34 or the arrowhead-like indicia 82 on the outward-facing surface 86 of the fingers, immediately know the direction to the source of the hose and know that such direction is to the outside of the burning building and away from the nozzle of the hose inside the building. Furthermore, because the tips 80 of finger 22 may extend well beyond the generally cylindrical body of male coupler 30, even a person wearing the densest, thickest gloves can detect their presence beyond the coupling to determine the direction of safety. Following the hose in the indicated direction allows the firefighter to exit the burning building.

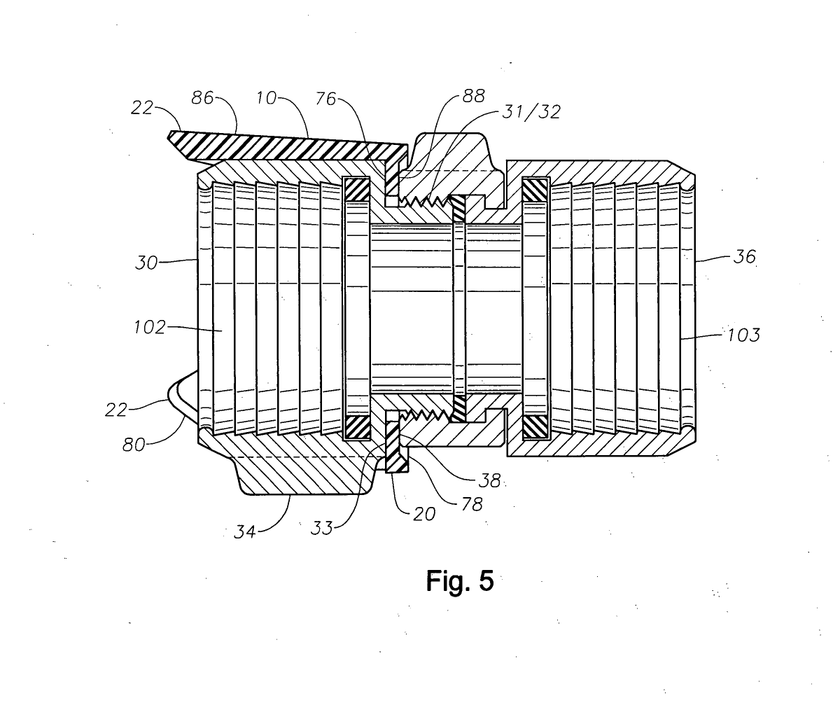

As shown in FIG. 5, the thickness of annular body 20 between the first and obverse faces 76, 78 along the perimeter radially outward of recess 88 is great enough to provide overall strength and rigidity. However, recess 88 is provided on the obverse face 78 of body 20 to accommodate female coupler 36 by receiving its shoulder 38. Recess 88 allows for complete engagement of threads 31, 32 either by hand or spanner wrench thereby preventing water leaks at the coupler connection. FIG. 5 also illustrates the serrated barbed inner surface 103 of female coupler 36 which captures the fabric firehose.

FIG. 6 illustrates several alternative embodiments of the invention. First, although the tips 80 of indicating device 10 preferably extend longitudinally past the male coupler 30 body for ready tactile identification as shown in FIG. 4, the tips 80 may alternatively not extend longitudinally past the male coupler 30 body as shown in FIG. 6. Second, FIG. 6 illustrates arrowhead-shaped indicia 82 as being raised above the outward facing surface 86 as opposed to being formed by a recessed groove as illustrated in FIG. 4. Third, the outward facing surface 86 may be molded to form a texture 87 fir improved tactile recognition. Alternatively, texture 87 may be formed by the use of a rough coating or by machining or knurling the outward facing surface 86. Any of these alternative embodiments may be used independently or in any combination.

The indicating devices of FIGS. 1-2 can be manufactured relatively inexpensively by injection molding techniques using a suitable plastic or rubber material. Strong engineering thermoplastics such as polysulfone, acetal, polycarbonate, and polyetheretherketone may be particularly desirable because they have excellent strength, impact and abrasion resistance, and high temperature stability.

Although the plastic or rubber material can be of bright colors such as yellow or orange to help the firefighters see the arrowhead fingers in limited light, the plastic more preferably includes phosphorescent, fluorescent and/or reflective particles therein for enhanced visual identification. More preferably still, the plastic includes luminescent material therein so that indicator 10 glows in the dark. Alternatively, a luminescent, phosphorescent, fluorescent and/or reflective coating may be applied to the indicator 10, or a portion thereof. For example, indicator 10 may be manufactured of a luminescent glow-in-the-dark plastic material, while indicia grooves 82 may be coated with a contrasting, fluorescent and reflective material to stand out clearly from the luminescent outward-facing finger surfaces 86. Preferably, indicia 82 will be in contrast to the outward-facing finger surfaces 86 in both light and dark conditions.

The Abstract of the disclosure is written solely for providing the United States Patent and Trademark Office and the public at large with a means by which to determine quickly from a cursory inspection the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

What is claimed is:

1. A directional indicator (10) for a firehose coupling system, the coupling system including a male coupler (30) with male threads (32) secured to a first section (50) of firehose, said male coupler having a generally cylindrical body with an annular shoulder (33) from which said male threads (32) extend outwardly and a plurality of raised longitudinal lugs (34) which define interposal coupler surfaces (104) between said lugs on said cylindrical body, said system including a female coupler (36) with female threads (31) secured to a second section (60) of firehose, said female coupler having a generally cylindrical body with an annular shoulder (38) from which said female threads extend inwardly, said female threads arranged and designed for securement to said male threads of said male coupler, the directional indicator (10) comprising,
a generally planar annular body (20) defining a plane and having a first face (76) which is arranged and designed to abut said annular shoulder (33) of said male coupler (30) and a second obverse face (78) which is arranged and designed to abut said annular shoulder (38) of said female coupler, and
a plurality of curved fingers (22) which are integral with said annular body with each of said fingers extending from said first face generally perpendicular to said plane of said annular body, each of said fingers (22) being arranged and designed for interjacent abutting placement between two lugs (34) of said male coupler (30) circumjacent said interposal coupler surface (104) and having a tip (80) extending longitudinally along said generally cylindrical body of said male coupler in a direction opposite the male threads such that a portion is circumjacent said first section of firehose.

2. The directional indicator of claim 1 wherein,
said tip of each of said fingers extends longitudinally beyond said generally cylindrical body of said male coupler.

3. The directional indicator of claim 1 further comprising,
a plurality of tactile indicia (82) each generally having a shape of an arrowhead and disposed on an outward facing surface (86) of one of said plurality of curved fingers.

4. The directional indicator of claim 1 further comprising,
a recess (88) disposed on said second obverse face of said annular body which accommodates said annular shoulder of said female coupler.

5. The directional indicator of claim 1 wherein,
each of said fingers has a generally irregular pentagon shape defined by a first curved base edge defined by a portion of said annular body at said first face, second and third side edges each being generally perpendicular to said base edge and connected thereto, and fourth and fifth edges, connected to said second and third edges, respectively, and generally forming said tip having an arrowhead shape pointing in a direction towards said first section of firehose, said second and third side edges each designed and arranged to abut a portion of one of said two lugs.

6. The directional indicator of claim 3 wherein,
said tactile indicia are defined by relief grooves.

7. The directional indicator of claim 3 wherein,
said tactile indicia are raised radially outward of said outward facing surfaces of said plurality of fingers.

8. The directional indicator of claim 1 wherein,
said generally planar annular body and said integral plurality of curved fingers are fabricated of a material which includes a plurality of luminescent particles.

9. The directional indicator of claim 1 wherein,
said generally planar annular body and said integral plurality of curved fingers are fabricated of a material which includes a plurality of phosphorescent particles.

10. The directional indicator of claim 1 wherein,
said generally planar annular body and said integral plurality of curved fingers are fabricated of a material which includes a plurality of fluorescent particles.

11. The directional indicator of claim 1 wherein,
said generally planar annular body and said integral plurality of curved fingers are fabricated of a material which includes a plurality of reflective particles.

12. The directional indicator of claim 1 wherein,
said plurality of curved fingers include a luminescent coating.

13. The directional indicator of claim 1 wherein,
said plurality of curved fingers include a phosphorescent coating.

14. The directional indicator of claim 1 wherein,
said plurality of curved fingers include a fluorescent coating.

15. The directional indicator of claim 1 wherein,
said plurality of curved fingers include a reflective coating.

16. The directional indicator of claim 2 wherein,
said tactile indicia include a coating which contrasts with said outward facing surfaces.

17. The directional indicator of claim 1 wherein,
said plurality of fingers are characterized by increasing thickness from said annular body (20) to said tips (80).

18. The directional indicator of claim 1 wherein,
said generally planar annular body and said integral plurality of curved fingers are fabricated of a thermoplastic material.

19. The directional indicator of claim 1 wherein,
said generally planar annular body and said integral plurality of curved fingers are fabricated of a rubber material.

20. The directional indicator of claim 3 wherein,
said outward facing surface has a texture (87).
